(19) United States
(12) Patent Application Publication
(10) Pub. No.: US 2023/0135163 A1
(43) Pub. Date: May 4, 2023

(54) Apparatus for Training Model, Method and Computer Readable Recording Medium Thereof

(71) Applicant: Hyperconnect Inc., Seoul (KR)

(72) Inventors: Jacob Richard Morton, Seoul (KR); Martin Kersner, Seoul (KR); Sang Il Ahn, Seoul (KR); Bu Ru Chang, Seoul (KR); Kwang Hee Choi, Seoul (KR)

(73) Assignee: Hyperconnect Inc., Seoul (KR)

(21) Appl. No.: 17/933,821

(22) Filed: Sep. 20, 2022

(30) Foreign Application Priority Data
Nov. 4, 2021 (KR) 10-2021-0150829
Jun. 8, 2022 (KR) 10-2022-0069423

(51) Int. Cl. G06N 3/08; G06N 3/04

(52) U.S. Cl. CPC G06N 3/08; G06N 3/0454

(57) ABSTRACT

Provided is a method for training a model, including generating a plurality of attention maps by inputting training data into a previously trained teacher model, generating a set of attention weights of the teacher model based on the plurality of attention maps, generating a set of attention weights of a student model by inputting the training data into the student model, calculating a value of a first loss function based on the set of attention weights of the teacher model and the set of attention weights of the student model, calculating a value of a second loss function according to an inference of the student model with respect to the training data, and training the student model based on the value of the first loss function and the value of the second loss function.

### CROSS-REFERENCE TO RELATED APPLICATION(S)

This application claims the benefit of Korean Patent Application No. 10-2021-0150829, filed on Nov. 4, 2021 and Korean Patent Application No. 10-2022-0069423, filed on Jun. 8, 2022, in the Korean Intellectual Property Office, the disclosures of which are incorporated herein by reference.

### BACKGROUND

### 1. Field of the Invention

The present disclosure relates to a device, a method and a computer readable recording medium for training a model to be deployed to a user terminal.

### 2. Description of the Related Art

As real-time communication becomes popular, data processing through an on-device model provided in a lightweight electronic device has attracted attention. In particular, speech recognition using the on-device model showed performance comparable to that of a large-scale model in tasks such as keyword spotting.

However, since the on-device model has limited memory and computing resources of the equipped electronic device, it also has a limitation in that performance is significantly poorer than that of the large-scale model in some tasks.

To overcome this, an attempt was made to transfer the knowledge of a large-scale model to the on-device model using a knowledge distillation-based mechanism, but the transfer could not be attempted unless the architecture of the large-scale model and the architecture of the on-device model were similar. Even if the transfer is attempted, there is a problem in that important temporal information in audio classification task is not transmitted well.

### SUMMARY

An aspect provides a device and a method that allow a general transfer of large-scale model knowledge to on-device models with various architectures.

The technical task to be achieved by the present disclosure is not limited to the technical tasks described above, and other technical tasks may be inferred from the following embodiments.

According to an aspect, there is provided a method for training a model, including generating a plurality of attention maps by inputting training data into a previously trained teacher model, generating a set of attention weights of the teacher model based on the plurality of attention maps, generating a set of attention weights of a student model by inputting the training data into the student model, calculating a value of a first loss function based on the set of attention weights of the teacher model and the set of attention weights of the student model, calculating a value of a second loss function according to an inference of the student model with respect to the training data, and training the student model based on the value of the first loss function and the value of the second loss function.

According to an embodiment, the teacher model may include a plurality of consecutive transformer layers, and the generating the plurality of attention maps may include generating an attention map from each of the plurality of consecutive transformer layers as the training data is input to the teacher model.

According to an embodiment, the generating the attention weights of the teacher model may include generating single unified attention map based on the plurality of attention maps, and generating the attention weights of the teacher model by extracting some of elements constituting the single unified attention map.

More specifically, the generating the attention weights of the teacher model by extracting some of elements constituting the single unified attention map may include extracting some of elements constituting the single unified attention map, identifying whether a dimension of an attention vector composed of the extracted elements and a dimension of the attention weights of the student model are identical, generating the attention vector composed of the extracted elements as the attention weights of the teacher model when the two dimensions are identical, and when the two dimensions are not identical, in order for the dimension of the attention vector composed of the extracted elements and the dimension of the attention weights of the student model to be identical, generating the attention weights of the teacher model by applying linear interpolation to the attention vector composed of the extracted elements.

According to an embodiment, the generating the attention weights of the student model may include generating a feature map for each time step by inputting the training data into the student model, and generating the attention weights of the student model based on the feature map for each time step and a query vector.

More specifically, the generating the attention weights of the student model based on the feature map for each time step and the query vector may include performing a vector operation between each feature map for each time step and the query vector, and applying an activated function to a vector having each result of the vector operation as a component.

According to an embodiment, the training the student model may include calculating a value of a final loss function by making a weighted sum of the value of the first loss function and the value of the second loss function, and updating at least some of a plurality of parameters of the student model and a query vector in a direction in which the value of the final loss function decreases.

According to an embodiment, the method for training a model may further include deploying an original or a copy of the trained student model as an on-device model to a user terminal.

In addition, the method for training a model may further include receiving a version update request of the on-device model from the user terminal, and providing the user terminal with information about one or more parameters of a recently updated student model in response to the version update request.

According to another aspect, there is provided a method for constructing a model, including acquiring, as an on-device model a student model trained by a knowledge distillation method from a server based on a teacher model of the server, transmitting a version update request of the on-device model to the server, and receiving information about one or more parameters of a recently updated student model from the server.

Meanwhile, according to another aspect, there is provided a server for training a model, including a memory to store instructions and a processor, wherein the processor is connected to the memory and configured to generate a plurality of attention maps by inputting training data into a previously trained teacher model, generate a set of attention weights of a teacher model based on the plurality of attention maps, generate a set of attention weights of the student model by inputting the training data into the student model, calculate a value of a first loss function based on the set of attention weights of a teacher model and the set of attention weights of the student model, calculate a value of a second loss function according to an inference of the student model with respect to the training data, and train the student model based on the value of the first loss function and the value of the second loss function.

According to an embodiment, the teacher model may include a plurality of consecutive transformer layers, and the processor, in generating the plurality of attention maps, may be configured to generate an attention map from each of the plurality of consecutive transformer layers as the training data is input to the teacher model.

According to an embodiment, the processor, in generating the attention weights of a teacher model, may be configured to generate single unified attention map based on the plurality of attention maps, and generate the attention weights of a teacher model by extracting some of elements constituting the single unified attention map.

More specifically, the processor, in generating the attention weights of a teacher model by extracting some of elements constituting the single unified attention map, may be configured to extract some of elements constituting the single unified attention map, identify whether a dimension of an attention vector composed of the extracted elements and a dimension of the attention weights of the student model are identical, generate the attention vector composed of the extracted elements as the attention weights of a teacher model when the two dimensions are identical, and when the two dimensions are not identical, in order for the dimension of the attention vector composed of the extracted elements and the dimension of the attention weights of the student model to be identical, generate the attention weights of a teacher model by applying linear interpolation to the attention vector composed of the extracted elements.

According to an embodiment, the processor, in generating the attention weights of the student model, may be configured to generate a feature map for each time step by inputting the training data into the student model, and generate the attention weights of the student model based on the feature map for each time step and a query vector.

More specifically, the processor, in generating the attention weights of the student model based on the feature map for each time step and the query vector, may be configured to perform a vector operation between each feature map for each time step and the query vector, and apply an activated function to a vector having each result of the vector operation as a component.

According to an embodiment, the processor, in training the student model, may be configured to calculate a value of a final loss function by making a weighted sum of the value of the first loss function and the value of the second loss function, and update at least some of a plurality of parameters of the student model and a query vector in a direction in which the value of the final loss function decreases.

According to an embodiment, the processor, after training the student model, may be configured to deploy an original or a copy of the trained student model as an on-device model to a user terminal.

In addition, the processor may be configured to receive a version update request of the on-device model from the user terminal, and provide the user terminal with information about one or more parameters of a recently updated student model in response to the version update request.

Meanwhile, according to another embodiment, an apparatus for building a model, as a user terminal for building the model, includes a memory to store instructions and a processor, and the apparatus acquires as an on-device model, a student model trained by a knowledge distillation method from a server based on a teacher model of the server, transmits a version update request of the on-device model to the server, and receives information about one or more parameters of a recently updated student model from the server.

Meanwhile, there may be provided a computer-readable recording medium in which a program for performing the method for training a model according to the present disclosure is recorded.

Additional aspects of example embodiments will be set forth in part in the description which follows and, in part, will be apparent from the description, or may be learned by practice of the disclosure.

According to embodiments, it is possible that the knowledge of a large-scale teacher model may be universally transferred to on-device models with various architectures, by performing the knowledge distillation mechanism based on attention vectors (attention weights) between the large-scale teacher model and the on-device models.

In addition, according to the present disclosure, it is possible to dramatically reduce the computing resources and time required to update the version of an on-device model, by enabling the version update of the on-device model simply by transferring information about the newly learned one or more parameters from the server to the mobile device (a user terminal).

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a schematic configuration illustrating an environment in which training a model and deployment is performed according to an embodiment;

FIG. 2 is a block diagram illustrating a server as an apparatus for training a model according to an embodiment;

FIG. 3 is a block diagram illustrating a user terminal as an apparatus for building a model according to an embodiment;

FIG. 4 is a flowchart illustrating a method for training a model in a server according to an embodiment;

FIG. 5 is a flowchart for describing operation S420 in more detail according to an embodiment;

FIG. 6 is a flowchart for describing operation S520 in more detail according to an embodiment;

FIG. 7 is a flowchart for describing operation S430 in more detail according to an embodiment;

FIG. 8 is a flowchart for describing operation S720 in more detail according to an embodiment;

FIG. 9 is a flowchart for describing operation S430 in more detail according to another embodiment;

FIG. 10 is a flowchart for describing operation S460 in more detail according to an embodiment;

FIG. 11 is a flowchart for describing a model deployment and an update method in a server according to an additional embodiment;

FIG. 12 is a flowchart illustrating a method for building a model in a user terminal according to an embodiment; and

FIG. 13 is an exemplary conceptual diagram illustrating an on-device model training method.

### DETAILED DESCRIPTION

Hereinafter, specific embodiments will be described with reference to the drawings. The detailed description below is provided for a comprehensive understanding of the methods, apparatuses and/or systems described herein. However, the embodiments are merely examples and the present disclosure is not limited thereto.

In describing the embodiments, when it is determined that a detailed description of the related known technology may unnecessarily obscure the gist of the disclosed embodiments, the detailed description will be omitted. In addition, the terms to be described later are terms defined in consideration of functions in the example embodiments of the present disclosure, which may vary according to intentions or customs of users and operators. Therefore, the definitions should be made based on the content throughout the present disclosure. The terms used in the detailed description are for the purpose of describing the embodiments only, and the terms should never be restrictive. Unless explicitly used otherwise, expressions in the singular include the meaning of the plural. In the present disclosure, expressions such as “include” or “comprise” are intended to refer to certain features, numbers, steps, acts, elements, some or a combination thereof, and the expressions should not be construed to exclude the presence or possibility of one or more other features, numbers, steps, acts, elements, or some or combinations thereof other than those described.

Terms used in the example embodiments are selected as currently widely used general terms as possible while considering the functions in the present disclosure. However, the terms may vary depending on the intention or precedent of a person skilled in the art, the emergence of new technology, and the like. Further, in certain cases, there are also terms arbitrarily selected by the applicant, and in the cases, the meaning will be described in detail in the corresponding descriptions. Therefore, the terms used in the present disclosure should be defined based on the meaning of the terms and the contents of the present disclosure, rather than the simple names of the terms.

Throughout the specification, when a part is described as “comprising or including” a component, it does not exclude another component but may further include another component unless otherwise stated. Furthermore, terms such as “ . . . unit,” “ . . . group,” and “ . . . module” described in the specification mean a unit that processes at least one function or operation, which may be implemented as hardware, software, or a combination thereof. Unlike used in the illustrated embodiments, the terms may not be clearly distinguished in specific operations.

Expression “at least one of a, b and c” described throughout the specification may include “a alone,” “b alone,” “c alone,” “a and b,” “a and c,” “b and c” or “all of a, b and c.”

In the present disclosure, a “terminal” may be implemented as, for example, a computer or a portable terminal capable of accessing a server or another terminal through a network. Here, the computer may include, for example, a notebook, a desktop computer, and/or a laptop computer which are equipped with a web browser. The portable terminal may be a wireless communication device ensuring a portability and a mobility, and include (but is not limited to) any type of handheld wireless communication device, for example, a tablet PC, a smartphone, a communication-based terminal such as international mobile telecommunication (IMT), code division multiple access (CDMA), W-code division multiple access (W-CDMA), long term evolution (LTE), or the like.

In the following description, terms “transmission,” “communication,” “sending,” “receiving” and other similar terms not only refer to direct transmission of a signal or information from one component to another component, but also include transmission via another component.

In particular, to “transmit” or “send” a signal or information to an element may indicate a final destination of the signal or information, and may not imply a direction destination. The same is applied to in “receiving” a signal or information. In addition, in the present disclosure, when two or more pieces of data or information are “related,” it indicates that when one piece of data (or information) is obtained, at least a part of the other data (or information) may be obtained based thereon.

Further, terms such as first and second may be used to describe various components, but the above components should be not limited by the above terms. The above terms may be used for the purpose of distinguishing one component from another component.

For example, without departing from the scope of the present disclosure, a first component may be referred to as a second component. Similarly, the second component may also be referred to as the first component.

In describing the example embodiments, descriptions of technical contents that are well known in the technical field to which the present disclosure pertains and that are not directly related to the present disclosure will be omitted. This is to more clearly convey the gist of the present disclosure without obscuring the gist of the present disclosure by omitting unnecessary description.

For the same reason, some elements are exaggerated, omitted or schematically illustrated in the accompanying drawings. In addition, the size of each element does not fully reflect the actual size. In each figure, the same or corresponding elements are assigned the same reference numerals.

Advantages and features of the present disclosure, and a method of achieving the advantages and the features will become apparent with reference to the example embodiments described below in detail together with the accompanying drawings. However, the present disclosure is not limited to the example embodiments disclosed below, and may be implemented in various different forms. The example embodiments are provided only so that the present disclosure to be complete, and completely inform the scope of the present disclosure to those of ordinary skill in the art to which the present disclosure pertains. The present disclosure is only defined by the scope of the claims. Like reference numerals refer to like elements throughout.

It will be understood that each block of a flowchart diagram and a combination of the flowchart diagrams may be performed by computer program instructions. The computer program instructions may be embodied in a processor of a general-purpose computer or a special purpose computer, or may be embodied in a processor of other programmable data processing equipment. Thus, the instructions, executed via a processor of a computer or other programmable data processing equipment, may generate a part for performing functions described in the flowchart blocks. To implement a function in a particular manner, the computer program instructions may also be stored in a computer-usable or computer-readable memory that may direct a computer or other programmable data processing equipment. Thus, the instructions stored in the computer usable or computer readable memory may be produced as an article of manufacture containing an instruction part for performing the functions described in the flowchart blocks. The computer program instructions may be embodied in a computer or other programmable data processing equipment. Thus, a series of operations may be performed in a computer or other programmable data processing equipment to create a computer-executed process, and the computer or other programmable data processing equipment may provide steps for performing the functions described in the flowchart blocks.

Additionally, each block may represent a module, a segment, or a portion of code that includes one or more executable instructions for executing a specified logical function(s). It should also be noted that in some alternative implementations the functions recited in the blocks may occur out of order. For example, two blocks shown one after another may be performed substantially at the same time, or the blocks may sometimes be performed in the reverse order according to a corresponding function.

Hereinafter, example embodiments of the present disclosure will be described in detail with reference to the accompanying drawings so that those of ordinary skill in the art to which the present disclosure pertains may easily implement them. However, the present disclosure may be implemented in multiple different forms and is not limited to the example embodiments described herein.

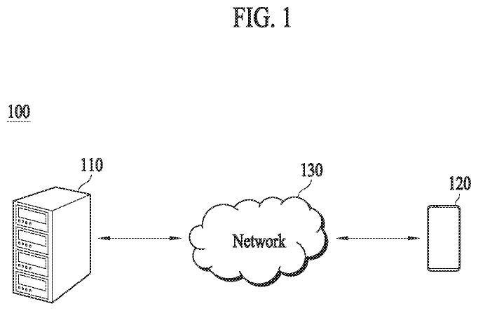

FIG. 1 is a schematic configuration illustrating an environment in which training a model and deployment is performed according to an embodiment. Referring to FIG. 1, the environment in which training and deploying of a model is made includes a server 110 and a user terminal 120. Here, the object to which the model is deployed to is the user terminal 120, and the object that performs training prior to deployment is the server 110, and thus the server 110 and the user terminal 120 may operate as one device for building a model. In addition, although it is illustrated in FIG. 1 as if there is one server and one user terminal, this is for convenience of understanding. According to an embodiment, the server may be composed of a plurality of detailed servers, and the user terminal may be plural. Meanwhile, it will be understood by those of ordinary skill in the art related to the present disclosure that other general-purpose components may be further included in addition to the components illustrated in FIG. 1.

The server 110 may perform an operation and transmit the operation result to the user terminal 120. More specifically, the server 110 may train a student model to be deployed to the user terminal 120 as an on-device model through knowledge distillation-based training using a teacher model. Subsequently, the server 110 may transmit the trained student model (or a copy thereof) to the user terminal 120 as an on-device model.

Meanwhile, the server 110 and the user terminal 120 may communicate with each other through a connected communication network, and/or communicate with another external device. The communication network includes a local area network (LAN), a wide area network (WAN), a value added network (VAN), a mobile radio communication network, a satellite communication network, and combination thereof. The communication network is a data communication network in a comprehensive sense that enables the constituent entities shown in FIG. 1 to communicate smoothly with each other, and may include a wired Internet, a wireless Internet, and a mobile wireless communication network. Wireless communication is, for example, wireless LAN (Wi-Fi), Bluetooth, Bluetooth low energy, Zigbee, Wi-Fi Direct (WFD), ultra-wideband (UWB) and infrared communication (infrared data association (IrDA)), but wireless communication is not limited thereto.

In relation to the above, the following drawings will be referred to for more detailed description.

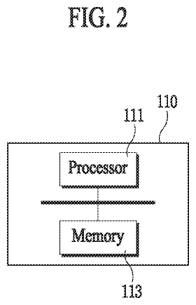

FIG. 2 is a block diagram illustrating a server as an apparatus for training a model according to an embodiment. Referring to FIG. 2, the server 110 as an apparatus for training a model according to the embodiment includes a processor 111 and a memory 113 storing instructions. The server 110 may receive a deployment request for an on-device model or a version update request for the on-device model from at least one user terminal, and the server 110 may transmit information required for deployment of the on-device model or information necessary for updating the version of the on-device model to the user terminal.

The processor 111 is connected to the memory 113, and generates a plurality of attention maps by inputting training data into a previously trained teacher model. The processor 111 generates a set of attention weights of the teacher model based on the plurality of attention maps, and inputs training data into the student model to generate a set of attention weights of the student model. The processor 111 calculates a value of a first loss function based on the set of attention weights of the teacher model and the set of attention weights of the student model, and calculates a value of a second loss function according to an inference of the student model on the training data. The processor 111 trains the student model based on the value of the first loss function and the value of the second loss function.

In the present disclosure, the “attention map” refers to a vector composed of attention values that numerically indicate how much weight each part of the data input for inference is considered when inferring the result for each part of the data input to the teacher model.

The teacher model may include a plurality of consecutive transformer layers. In this case, in generating the plurality of attention maps, the processor 111 may generate an attention map from each of the plurality of consecutive transformer layers as training data is input to the teacher model.

According to an embodiment, the teacher model may be an automatic speech recognition (ASR) model based on a transformer. For example, the teacher model may include the structure of wav2vec 2.0.

According to an embodiment, the training data may be translated into a plurality of latent representations of each time step through a convolutional feature encoder in the teacher model. Such latent representations for each time step may be output as feature maps (context representations) for the training data while passing through the plurality of consecutive transformer layers. In the meantime, the processor 111 may calculate an attention value by using a hidden state in an encoder or a decoder in each transformer layer as a query, a key and a value of the attention function, and the processor 111 may generate an attention map composed of attention values. As an example, the processor 111 may calculate a self-attention value by using each part of the training data (for example, when the training data is a sentence, vectors of each word constituting the sentence) as a query, a key and a value of the attention function, and the processor 111 may generate a self-attention map composed of the self-attention values.

In generating the attention weights of the teacher model, the processor 111 may generate single unified attention map based on a plurality of attention maps, and may extract some of elements constituting the single unified attention map to generate the attention weights of the teacher model. In this case, the single unified attention map may be an attention map that is generated through a vector operation among the plurality of attention maps and has the same dimension as each of the plurality of attention maps. However, the single unified attention map is not limited thereto.

According to an embodiment, the processor 111 may generate a single unified attention map by applying an attention rollout technique to the plurality of attention maps. Specifically, the processor 111 may generate a single unified attention map by recursively multiplying the attention weights that are forwardly propagated from an attention map corresponding to the lowest transformer layer to an attention map corresponding to the highest transformer layer.

According to an embodiment, the processor 111 may generate the attention weights of the teacher model by extracting elements of a specific row or a specific column corresponding to a specific time step from among the elements constituting the single unified attention map. For example, the processor 111 may extract elements in row 1 as the attention weights of the teacher model from the single unified attention map including n*n elements.

According to an embodiment, in generating a teacher attention vector by extracting some of the elements constituting the single unified attention map, the processor 111 may extract some of the elements constituting the single unified attention map and identify whether the dimension of the attention vector composed of the extracted elements and the dimension of the attention weights of a student model are identical. When the two dimensions are identical, the processor 111 may generate the attention vector composed of the extracted elements as the attention weights of the teacher model. If the two dimensions are not identical, the processor 111 may generate the attention weights of the teacher model by applying linear interpolation to the attention vector composed of the extracted elements so that the dimension of the attention vector composed of the extracted elements and the dimension of the attention weights of the student model to be identical. With regard to this, by applying the linear interpolation, the dimension of the attention weights of the teacher model to be derived may be determined by one or more preset hyper-parameter.

The student model may be a convolutional neural network (CNN)-based model (for example, TC-ResNet), a recurrent neural network (RNN)-based model (for example, LSTM-P), a model using both CNN and RNN (for example, CRNN), an attention mechanism-based model (for example, Att-RNN), or a model taking a multi-head variant of Att-RNN (for example, MHAtt-RNN). For the purpose of an audio classification task, the student model may include a mel-frequency cepstral coefficient (MFCC) based feature encoder.

In generating the attention weights of the student model, the processor 111 may generate a feature map for each time step by inputting training data into the student model, and may generate a set of attention weights of the student model based on the feature map for each time step and a query vector. More specifically, in generating the set of attention weights of the student model based on the feature map for each time step and the query vector, the processor 111 may perform a vector operation between each feature map for each time step and the query vector, and may generate the set of attention weights of the student model by applying an activated function to a vector having a result of each vector operation as a component. In related embodiments, time steps of feature maps (context representations) generated by the student model may not be identical to time steps of the feature maps generated by the teacher model. This is because the time steps and dimensions of the feature maps of the student model may vary depending on the architecture of the student model. Accordingly, although the dimensions of the attention weights of the teacher model and the attention weights of the student model may be different, the processor 111 may transfer information about the attention weights of the teacher model to the student model, thereby ensuring architectural diversity of the student model, which will become an on-device model.

In the present disclosure, the “query vector” is a vector as a medium for calculating the attention vector (the attention weights of the student model) for knowledge distillation from the feature maps (context representations) generated by the student model, and an initial value of the query vector may be determined using various methods. Further, the dimension of the query vector may be predetermined according to the architecture of the student model.

According to an embodiment, an activated function applied by the processor 111 may be a softmax function for normalizing elements of each vector, but is not limited thereto. For vector processing, various activated functions such as the rectified linear unit (ReLU) function and a sigmoid function may be applied.

According to an embodiment, the processor 111 may randomly set an initial value of a query vector (random initialization).

According to another embodiment, the processor 111 may select one of the feature maps generated by the student model, or the processor 111 may calculate a representative value (for example, the mean and the median) for each element of the feature maps generated by the student model and then the processor 111 may set an initial value of the query vector by projecting it on the set reference vector or reference axis.

Further, according to an embodiment, the processor 111 may generate an initial target attention vector having a scalar value for each time step that is an inner product calculated with the feature map for each time step and query vector, as an element, and the processor 111 may generate the attention weights of the student model by taking a softmax function on the initial target attention vector. This is as shown in Equation 1 below. However, it should be noted that the vector operation between a feature map for each time step and a query vector is not limited to the calculating the inner product.

a_{S}=softmax(c′ᵢ·q)ᵢ₌₁^{n′} [Equation 1]

Here, a_{S} represents the attention weights of the student model, c′ᵢ represents a feature map for each time step, q represents a query vector, and i represents a variable for each time step.

In generating the attention weights of the student model, if the student model is a neural network model based on the attention mechanism, the processor 111 may use the attention vector output by the student model from the inputting the training data, as the attention weights of the student model.

In training the student model, the processor 111 may calculate a value of a final loss function by making a weighted sum of values of the first loss function and the second loss function, and the processor 111 may update at least some of the plurality of parameters of the student model and the query vector in a direction in which the value of the final loss function decreases.

According to an embodiment, the first loss function may be a Kullback-Leibler divergence (KLD) with the attention weights of the teacher model and the attention weights of the student model as inputs.

According to an embodiment, the first loss function may be calculated by Equation 2 below.

[symbol]

_{KL}=D_{KL}(a_{S}|a_{T}) [Equation 2]

Here, [symbol] _{KL} represents a first loss function, D_{KL} represents a Kullback-Leibler divergence, a_{T} represents the attention weights of the teacher model and a_{S} represents the attention weights of the student model.

According to an embodiment, the second loss function may be a cross-entropy function.

According to an embodiment, a final loss function may be calculated by Equation 3 below.

[symbol]

=λ [symbol] _{KL}+(1−λ) [symbol] _{CLS} [Equation 3]

Here, [symbol] represents a final loss function, [symbol] _{KL} represents a first loss function, [symbol] _{CLS} represents a second loss function, λ represents a weight (a hyper-parameter) for determining the reflection ratio of a value of the first loss function and a value of the second loss function when calculating a value of the final loss function.

The processor 111 may deploy an original or a copy of the trained student model as an on-device model, to the user terminal 120.

According to an embodiment, when receiving an on-device deployment request from the user terminal 120, in response to this, the processor 111 may provide the user terminal 120 with information necessary for deployment of an original or a copy of the trained student model. With regard to this, the on-device deployment request of the user terminal 120 may be made within an application provided in the user terminal 120, may be made through an operating system software installation request of the user terminal 120, or may be made through a firmware installation request of the user terminal 120.

The processor 111 may receive a version update request of the on-device model from the user terminal 120, and may provide information about parameters of the recently updated student model to the user terminal 120 in response to the version update request. With regard to this, the version update request for the on-device model of the user terminal 120 may be made within an application provided in the user terminal 120, or through an operating system software upgrade of the user terminal 120, or through a firmware upgrade of the user terminal 120.

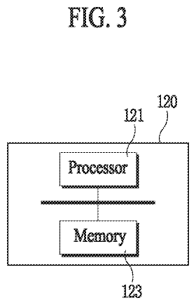

FIG. 3 is a block diagram illustrating a user terminal as an apparatus for building a model according to an embodiment. Referring to FIG. 3, the user terminal 120 as an apparatus for building a model according to an embodiment includes a processor 121 and a memory 123 storing instructions. The user terminal 120 may receive information required for deployment of the on-device model or information required for updating the version of the on-device model from the server 110, and may transmit a deployment request for the on-device model or a version update request for the on-device model to the server 110.

Being connected to the memory 123, the processor 121 acquires, as an on-device model, a student model trained by a knowledge distillation method based on a teacher model of the server 110 from the server 110, transmits a version update request of the on-device model to the server 110, and receives information on parameters of a recently updated student model from the server 110.

According to an embodiment, the processor 121 may receive information required for deployment of the on-device model from the server 110, and may build an on-device model in the user terminal 120 based on this. For example, information required for deployment of the on-device model received by the processor 121 may be code information defining the architecture and parameters of the on-device model.

According to an embodiment, the processor 121 may receive information about the parameters of the recently updated student model from the server 110, and may update the parameters of the on-device model built in the user terminal 120 based on the information.

According to an embodiment, the processor 121 may additionally receive information on the latest version of the student model while receiving information about the parameters of the recently updated student model from the server 110, and after the update of the on-device model built in the user terminal 120 is made, the processor 121 may modify version information of the on-device model built in the user terminal 120 based on the latest version information.

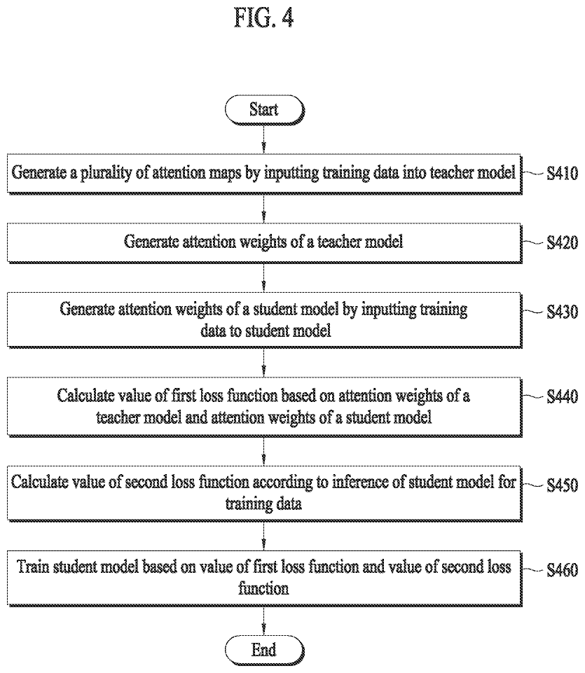

FIG. 4 is a flowchart illustrating a method for training a model in a server according to an embodiment.

In operation S410, the server 110 generates a plurality of attention maps by inputting training data into a previously trained teacher model.

In operation S420, the server 110 generates a set of attention weights of the teacher model based on the plurality of generated attention maps.

In operation S430, the server 110 generates a set of attention weights of the student model by inputting training data to the student model.

In operation S440, the server 110 calculates a value of a first loss function based on the set of attention weights of the teacher model and the set of attention weights of the student model.

In operation S450, the server 110 calculates a value of a second loss function according to an inference of the student model for training data.

In operation S460, the server 110 trains the student model based on the value of the first loss function and the value of the second loss function.

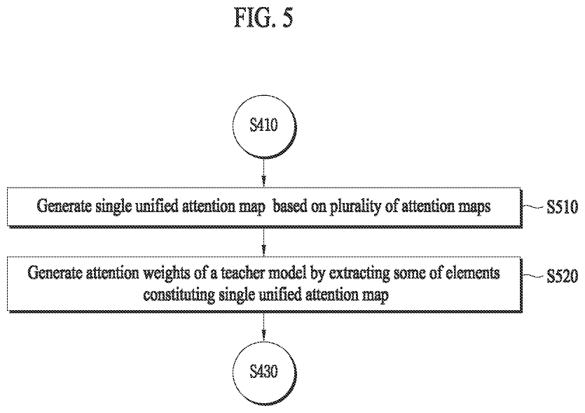

FIG. 5 is a flowchart for describing operation S420 in more detail according to an embodiment.

In operation S510, the server 110 generates single unified attention map based on the plurality of attention maps generated in operation S410.

In operation S520, the server 110 generates a set of attention weights of the teacher model by extracting some of the elements constituting the generated single unified attention map.

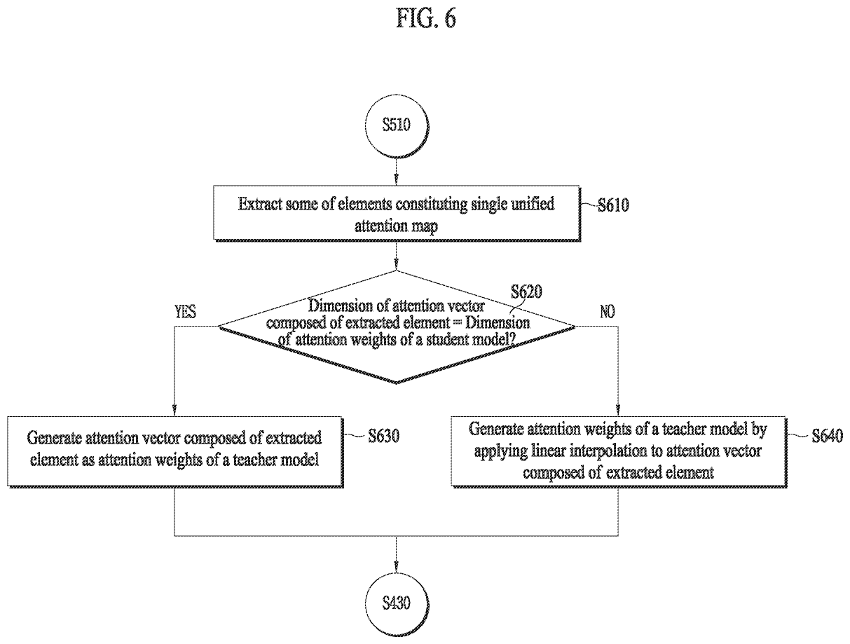

FIG. 6 is a flowchart for describing operation S520 in more detail according to an embodiment.

In operation S610, the server 110 extracts some of the elements constituting the single unified attention map.

In operation S620, the server 110 identifies whether the dimension of the attention vector composed of the extracted elements and the dimension of the attention weights of a student model are identical.

In operation S630, when the dimension of the attention vector composed of the extracted elements and the dimension of the attention weights of a student model are identical, the server 110 generates the attention vector composed of the extracted elements as the attention weights of the teacher model.

Further, in operation S640, if the dimension of the attention vector composed of the extracted elements and the dimension of the attention weights of the student model are not identical, the server 110 generates the attention weights of the teacher model by applying linear interpolation to the attention vector composed of the extracted elements so that the dimension of the attention vector composed of the extracted elements and the dimension of the attention weights of the student model to be identical.

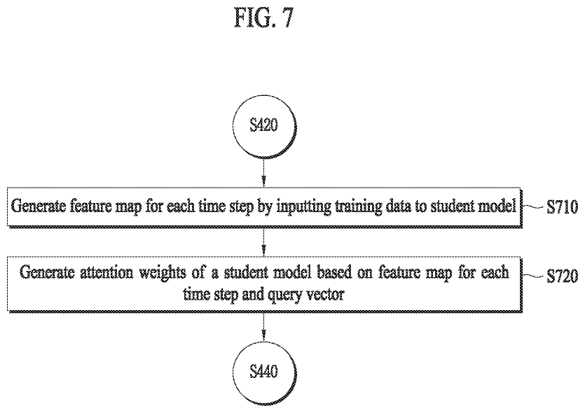

FIG. 7 is a flowchart for describing operation S430 in more detail according to an embodiment.

In operation S710, the server 110 generates a feature map for each time step by inputting training data to the student model.

In operation S720, the server 110 generates the attention weights of the student model based on the feature map for each time step and a query vector.

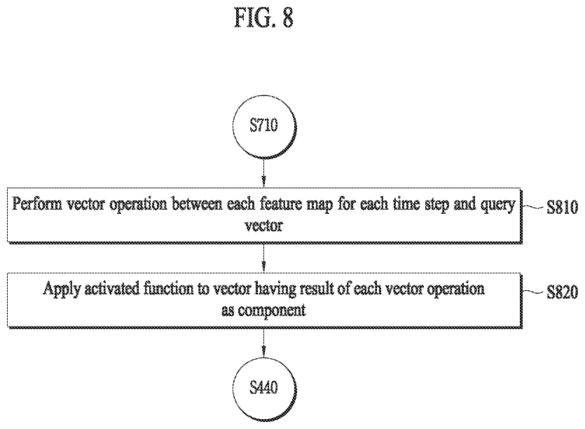

FIG. 8 is a flowchart for describing operation S720 in more detail according to an embodiment.

In operation S810, the server 110 performs a vector operation between each feature map for each time step and a query vector.

In operation S820, the server 110 applies an activated function to a vector having the result of each vector operation as a component.

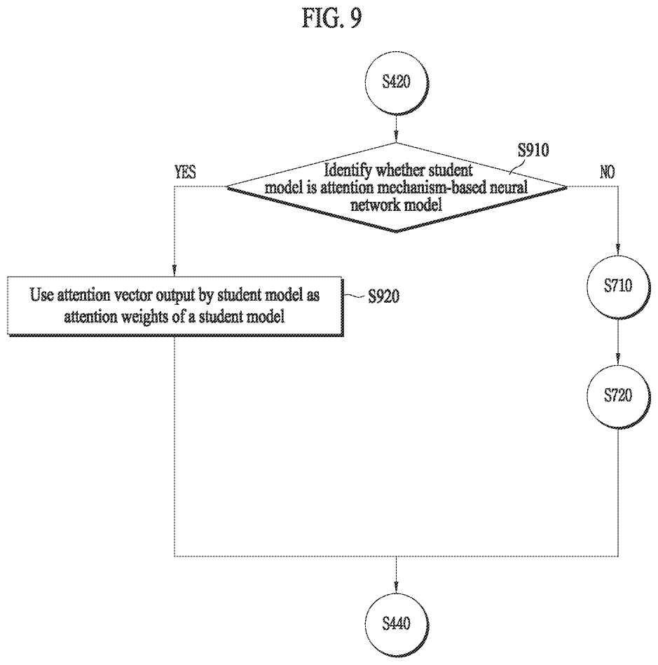

FIG. 9 is a flowchart for describing operation S430 in more detail according to another embodiment.

In operation S910, the server 110 identifies whether the student model is an attention mechanism-based neural network model.

In operation S920, when the student model is a neural network model based on an attention mechanism, the server 110 uses an attention vector output by the student model from inputting the training data, as the attention weights of the student model.

Meanwhile, when the student model is not an attention mechanism-based neural network model, the server 110 generates the attention weights of the student model through operations S710 and S720.

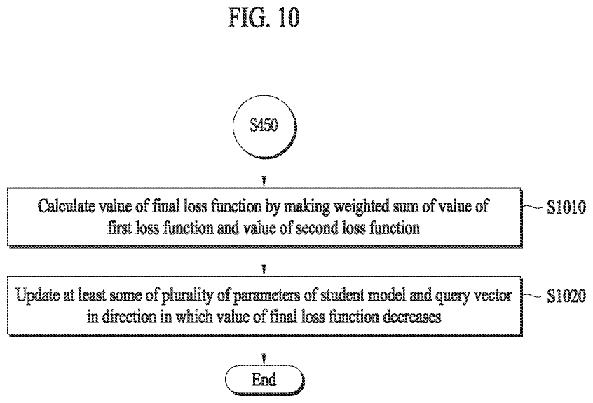

FIG. 10 is a flowchart for describing operation S460 in more detail according to an embodiment.

In operation S1010, the server 110 calculates a value of a final loss function by making a weighted sum of the value of the first loss function and the value of second loss function.

In operation S1020, the server 110 updates at least some of the plurality of parameters of the student model and a query vector in a direction in which the value of the final loss function decreases.

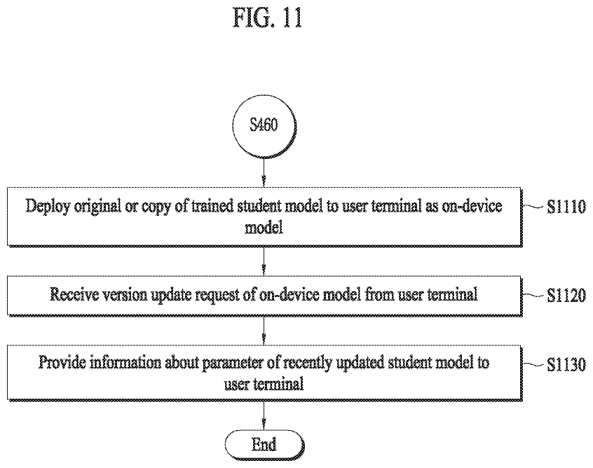

FIG. 11 is a flowchart for describing a model deployment and an update method in a server according to an additional embodiment.

In operation S1110, the server 110 deploys an original or a copy of the trained student model to the user terminal 120 as an on-device model.

In operation S1120, the server 110 receives a version update request of the on-device model from the user terminal 120.

In operation 51130, the server 110 provides information about the parameters of the recently updated student model to the user terminal 120 in response to the received version update request.

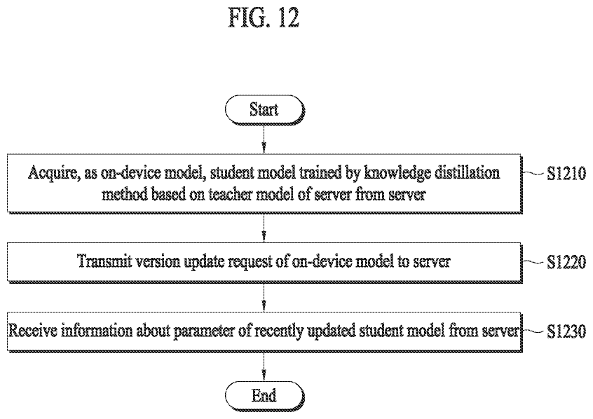

FIG. 12 is a flowchart illustrating a method for building a model in a user terminal according to an embodiment.

In operation S1210, the user terminal 120 acquires, as an on-device model, a student model trained by a knowledge distillation method based on the teacher model of the server 110 from the server 110.

In operation S1220, the user terminal 120 transmits a version update request of the on-device model to the server 110.

In operation 51230, the user terminal 120 receives information about the parameters of the recently updated student model from the server 110.

In the illustrated flowchart, the method is divided and described in a plurality of operations. However, at least some of the operations may be performed out of order, may be performed together in combination with other operations, may be omitted, or may be performed by being divided into detailed operations. Or, one or more operations not illustrated may be added and performed.

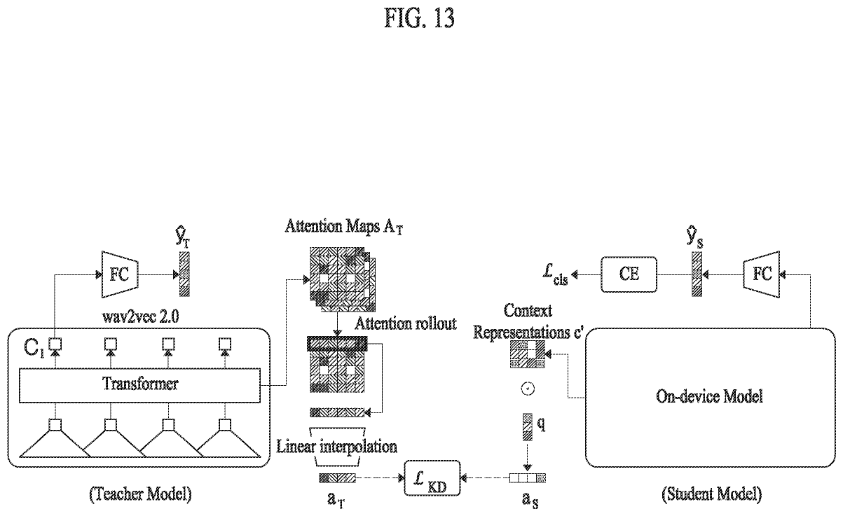

FIG. 13 is an exemplary conceptual diagram illustrating an on-device model training method.

Specifically, FIG. 13 conceptually illustrates the knowledge distillation process of the teacher model and the student model performed by the server 110.

Referring to FIG. 13, the teacher model receives training data through multiple encoders, and the teacher model generates a feature map for each time step through a plurality of transformer layers (FIG. 13 is shown as one transformer block). As illustrated, the feature map corresponding to a first time step is output as an inference result (ŷ_{T}) corresponding to the first time step through a fully-connected (FC) layer.

Meanwhile, the server 110 may generate a single unified attention map through a vector operation (for example, attention rollout) from a plurality of attention maps (A_{T}) generated from the transformer layers of the teacher model. By extracting some of the elements therefrom and applying linear interpolation, the server 110 may generate a set of attention weights of the teacher model (a_{T}).

Further, the server 110 may generate a set of attention weights of the student model (a_{S}) through a vector operation (for example, calculating an inner product) between a feature map (a context representation, c′) generated through the student model and a query vector. Furthermore, the server 110 may calculate a first loss function value ( [symbol] _{KS}) by inputting a set of attention weights of the teacher model value and a set of attention weights of the student model value as inputs. Meanwhile, the server 110 may calculate a second loss function value ( [symbol] _{cls}) based on the second loss function (cross-entropy; CE) between the inference result (ŷ_{S}) of the student model and the correct answer label.

Then, the server 110 may calculate a final loss function value based on the first loss function value and the second loss function value. Based on the final loss function this, the server 110 may update (1) at least some of a plurality of parameters in the student model and (2) a query vector.

The electronic device according to the above-described embodiments may include a processor, a memory for storing and executing program data, a permanent storage such as a disk drive, and a user interface device such as a communication port, a touch panel, a key and a button that communicates with an external device. Methods implemented as software modules or algorithms may be stored in a computer-readable recording medium as computer-readable codes or program instructions executable on the processor. Here, the computer-readable recording medium includes a magnetic storage medium (for example, ROMs, RAMs, floppy disks and hard disks) and an optically readable medium (for example, CD-ROMs and DVDs). The computer-readable recording medium may be distributed among network-connected computer systems, so that the computer-readable codes may be stored and executed in a distributed manner. The medium may be readable by a computer, stored in a memory, and executed on a processer.

The embodiments may be represented by functional block elements and various processing steps. The functional blocks may be implemented in any number of hardware and/or software configurations that perform specific functions. For example, an example embodiment may adopt integrated circuit configurations, such as memory, processing, logic and look-up table, that may execute various functions by the control of one or more microprocessors or other control devices. Similar to that elements may be implemented as software programming or software elements, the example embodiments may be implemented in a programming or scripting language such as C, C++, Java, assembler, etc., including various algorithms implemented as a combination of data structures, processes, routines, or other programming constructs. Functional aspects may be implemented in an algorithm running on one or more processors. Further, the example embodiments may adopt the existing art for electronic environment setting, signal processing, message processing and/or data processing. Terms such as “mechanism,” “element,” “means” and “configuration” may be used broadly and are not limited to mechanical and physical elements. The terms may include the meaning of a series of routines of software in association with a processor or the like.

The above-described example embodiments are merely examples, and other embodiments may be implemented within the scope of the claims to be described later.

What is claimed is:

1. A method for training a model, comprising:
generating a plurality of attention maps by inputting training data into a previously trained teacher model;
generating a set of attention weights of the teacher model based on the plurality of attention maps;
generating a set of attention weights of a student model by inputting the training data into the student model;
calculating a value of a first loss function based on the set of attention weights of the teacher model and the set of attention weights of the student model;
calculating a value of a second loss function according to an inference of the student model with respect to the training data; and
training the student model based on the value of the first loss function and the value of the second loss function.

2. The method of claim 1, wherein the teacher model comprises a plurality of consecutive transformer layers, and
wherein the generating the plurality of attention maps comprises generating an attention map from each of the plurality of consecutive transformer layers as the training data is input to the teacher model.

3. The method of claim 1, wherein the generating the attention weights of the teacher model comprises:
generating single unified attention map based on the plurality of attention maps; and
generating the attention weights of the teacher model by extracting some of elements constituting the single unified attention map.

4. The method of claim 3, wherein the generating the attention weights of the teacher model by extracting some of elements constituting the single unified attention map comprises:
extracting some of elements constituting the single unified attention map;
identifying whether a dimension of an attention vector composed of the extracted elements and a dimension of the attention weights of the student model are identical; and
generating the attention vector composed of the extracted elements as the attention weights of the teacher model when the two dimensions are identical;
when the two dimensions are not identical, in order for the dimension of the attention vector composed of the extracted elements and the dimension of the attention weights of the student model to be identical, generating the attention weights of the teacher model by applying linear interpolation to the attention vector composed of the extracted elements.

5. The method of claim 1, wherein the generating the attention weights of the student model comprises:
generating a feature map for each time step by inputting the training data into the student model; and
generating the attention weights of the student model based on the feature map for each time step and a query vector.

6. The method of claim 5, wherein the generating the attention weights of the student model based on the feature map for each time step and the query vector comprises:
performing a vector operation between each feature map for the each time step and the query vector; and
applying an activated function to a vector having each result of the vector operation as a component.

7. The method of claim 1, wherein the training the student model comprises:
calculating a value of a final loss function by making a weighted sum of the value of the first loss function and the value of the second loss function; and
updating at least some of a plurality of parameters of the student model and a query vector in a direction in which the value of the final loss function decreases.

8. The method of claim 1, further comprising deploying an original or a copy of the trained student model as an on-device model to a user terminal.

9. The method of claim 8, further comprising:
receiving a version update request of the on-device model from the user terminal; and
providing the user terminal with information about one or more parameters of a recently updated student model in response to the version update request.

10. A method for constructing a model, comprising:
acquiring, as an on-device model, a student model trained by a knowledge distillation method from a server based on a teacher model of the server;
transmitting a version update request of the on-device model to the server; and
receiving information about one or more parameters of a recently updated student model from the server.

11. A computer-readable recording medium comprising a computer program to execute the method of claim 1.

12. A server for training a model, comprising a memory to store instructions and a processor,
wherein the processor is connected to the memory and configured to:
generate a plurality of attention maps by inputting training data into a previously trained teacher model;
generate a set of attention weights of the teacher model based on the plurality of attention maps;
generate a set of attention weights of a student model by inputting the training data into the student model;
calculate a value of a first loss function based on the set of attention weights of the teacher model and the set of attention weights of the student model;
calculate a value of a second loss function according to an inference of the student model with respect to the training data; and
train the student model based on the value of the first loss function and the value of the second loss function.

13. The server of claim 12, wherein the teacher model comprises a plurality of consecutive transformer layers, and
wherein the processor, in generating the plurality of attention maps, is configured to generate an attention map from each of the plurality of consecutive transformer layers as the training data is input to the teacher model.

14. The server of claim 12, wherein the processor, in generating the attention weights of the teacher model, is configured to:
generate single unified attention map based on the plurality of attention maps; and
generate the attention weights of the teacher model by extracting some of elements constituting the single unified attention map.

15. The server of claim 14, wherein the processor, in generating the attention weights of the teacher model by extracting some of elements constituting the single unified attention map, is configured to:
extract some of elements constituting the single unified attention map;
identify whether a dimension of an attention vector composed of the extracted elements and a dimension of the attention weights of the student model are identical;
generate the attention vector composed of the extracted elements as the attention weights of the teacher model when the two dimensions are identical; and
when the two dimensions are not identical, in order for the dimension of the attention vector composed of the extracted elements and the dimension of the attention weights of the student model to be identical, generate the attention weights of the teacher model by applying linear interpolation to the attention vector composed of the extracted elements.

16. The server of claim 12, wherein the processor, in generating the attention weights of the student model, is configured to:
generate a feature map for each time step by inputting the training data into the student model; and
generate the attention weights of the student model based on the feature map for each time step and a query vector.

17. The server of claim 16, wherein the processor, in generating the attention weights of the student model based on the feature map for each time step and the query vector, is configured to:
perform a vector operation between each feature map for the each time step and the query vector; and
apply an activated function to a vector having each result of the vector operation as a component.

18. The server of claim 12, wherein the processor, in training the student model, is configured to:
calculate a value of a final loss function by making a weighted sum of the value of the first loss function and the value of the second loss function; and
update at least some of a plurality of parameters of the student model and a query vector in a direction in which the value of the final loss function decreases.

19. The server of claim 12, wherein the processor is configured to deploy an original or a copy of the trained student model as an on-device model to a user terminal.

20. The server of claim 19, wherein the processor is configured to:
receive a version update request of the on-device model from the user terminal; and
provide the user terminal with information about one or more parameters of a recently updated student model in response to the version update request.
